(19) United States
(12) Patent Application Publication
(10) Pub. No.: US 2008/0000827 A1
(43) Pub. Date: Jan. 3, 2008

(54) Frameless, Plate-Shaped Filtering Member

(76) Inventor: Ulrich Bruss, Nottuln (DE)

Correspondence Address: K.F. ROSS P.C., 5683 RIVERDALE AVENUE, SUITE 203 BOX 900, BRONX, NY, 10471-0900, US

(21) Appl. No.: 11/667,647

(22) PCT Filed: Nov. 5, 2005
(86) PCT No.: PCT/DE05/01992

§ 371 Date: May 10, 2007

(30) Foreign Application Priority Data
Nov. 26, 2004 (DE) 10 2004 057 107.4

(51) Int. Cl. B01D 63/08; B01D 65/00; B01D 69/10

(52) U.S. Cl. 210/490; 210/489

(57) ABSTRACT

The invention relates to a frameless, plate-shaped filtering member comprising exterior filter layers (17) that encompass at least one layer of membrane material (19). At least one layer (12), at least one face of which is provided with elevations (15) that are distributed across the surface and are spaced apart from each other, is disposed between the exterior filter layers. The faces of said elevations form a contact area for another, preferably liquid-permeable layer (13, 14).

The invention relates to a frameless plate-shaped filter element, particularly for filtering liquid media, comprising outer filter layers made of at least one layer of membrane material.

For the separation of particles from fluids, filter systems are known that operate with rotating filter disks, with filtration capillaries or tubes or with filter panels that extend into the fluid to be purified. In general, a plurality of filter elements are combined in a filtration module. All systems share the characteristic that thin filter membranes are used for filtering the fluid, which membranes have a frame structure on the filtrate side for discharging the filtrate. The difference in pressure required for the filtration operation is produced by sucking out the filtrate. The filter element as well as the filter membranes must therefore have sufficient strength to withstand this pressure.

Mechanical strength is additionally a prerequisite form a uniform filtration performance of the filter element. It guarantees even distribution of the pressure difference across the filter membrane as well as effective discharge of the filtrate with little loss of pressure. As the filter element increases in size, the requirements in regard to its flex strength rise as well.

We know of filtration modules in which a plurality of filter panels are mounted at a spacing from and oriented parallel to each other in a housing or on a support plate. A filtration module of this type is described in EP 0 602 560 B1 [U.S. Pat. No. 5,651,888]. The filter panels are stabilized by an inside, rigid plate made of plastic. In addition, spacers are provided between the outer filter membrane and the plate to create a space for the discharge of the filtrate.

A different embodiment of a rigid filter panel that can be inserted in a filtration module is described in DE 199 10 974 A1. Here, the filter membranes are in a closed frame. The frame, like the plastic plate referred to above, is intended to have a stabilizing effect and additionally enable discharge of the filtrate even without spacers via the space enclosed by the frame.

The use of rigid frames or plates as substructures is associated with high material expenses as well as high weight of the filter panel. When additionally recesses are integrated in the surface of stabilizing plates for discharging of the filtrate, high manufacturing expenses are also incurred since manufacture is usually done by a complex injection-molding processes. In addition, panels of this type can only be produced in small sizes.

EP 0 591 117 A1 [U.S. Pat. No. 5,429,744] proposes using “spacers” as the substructure instead of a heavy panel or frame. The spacer in the described filter element is made of strings positioned in a mutually crossing pattern, forming a grid construction that on the one hand provides the filter membranes with tensile strength, and on the other hand allows the filtrate to be removed via the cavities of the grid construction. The flex strength of this filter panel, however, is limited.

From DE 202 07 359 U1 a self-supporting filter panel is known in which a fabric made of yarns, filaments or wires, made of polymers or metals, is used as the spacer. To increase flex strength, the configuration consisting of membrane/spacer/membrane is also folded. By resting the filter membrane on the spacer across its entire surface, the strength of the filter panel is increased, however this impairs cleaning of the filter membrane of filtration-inhibiting deposits. During cleaning, gas is introduced from below into the immersed filtration device, and a higher flow speed is generated by means of propellers or pumps in the area of the membrane surface. To be able to effectively clean the filter membranes from deposits, however, the filter membranes must be displaceable at least to some extent in the fluid flow.

It is therefore the object of the present invention to create a filter element without the disadvantages outlined above, which member in particular has a high flex strength, allows effective filtrate discharge and additionally can be easily produced as a large plate with low material consumption and low weight.

This object is achieved with a filter element according to claim 1, wherein according to the invention between the outer filter layers at least one layer is mounted that on at least one face, preferably on both faces, comprises a plurality of bumps that are distributed across the face and are spaced from each other and the end surfaces of which form a contact surface for a further, preferably fluid-permeable layer. Such a construction has a simple design, is inexpensive to produce and enables uniform filtration performance due to an even distribution of the pressure difference.

Embodiments of the filter element according to the invention are described in the dependent claims.

The outer fluid-permeable layer, for example, preferably has a plurality of perforations that are preferably distributed equidistantly across its entire surface and in one embodiment of the invention are at least substantially circular, have a diameter of 0.1 mm to 5 mm and/or a spacing from center to center of 2 to 50 mm.

The bumps can have a circular, oval or polygonal cross-section.

The inner layer mentioned above as well as the outer fluid-permeable layer are made of polymer, polypropylene being particularly preferred.

According to one concrete embodiment, at least one face of the inner layer has a regular structure with bumps and recesses, the bumps preferably having a circular, oval or polygonal cross-section.

The nub-like bumps are furthermore preferably have flat end surfaces, so that they form a planar abutment surface. The abutment surface is suited for contact with the outer layer and/or the filter layer. In the case of large-format filter elements or other filter elements subject to high requirements in terms of their flex strength, the outer layer and/or the filter layer can be connected in the region of the abutment surfaces at points with the inner layer through suitable connecting means or by pressing or welding. The abutment surfaces also enable the joining of two or more layers with the same nub-like bumps. The inner layer and the outer layer are preferably made of polymer, particularly polypropylene.

In a further embodiment, fluid-permeable gauze is applied against the inner layer with the holes to support the discharge of filtrate. The filter layer comprising at least one layer of membrane material is then applied to the gauze.

Also an embodiment according to which at least one tight, fluid-permeable gauze forms the outer layer between the filter membrane and the inner layer is preferred. In this embodiment, the layer with the holes is eliminated.

In order to seal the edge regions of the plate-shaped filter element, the outer filter layer is connected with at least one outer layer and/or the above-mentioned layer by means of pressing, gluing, welding or filling so that the edge region is is completely or at least partially fluid-tight. It is preferable if at least one opening is provided in the edge region for discharging the filtrate. The otherwise fluid-tight design of the edge regions prevents unfiltered fluid from getting into the filter element.

The membrane material of the filter layer is preferably made of polyphenol, polyether sulfone, polyvinylidenefluoride, polyamide, polyetherimide, cellulose acetate, polyolefin or fluoropolymer.

A plurality of plate-shaped filter elements having the same configuration and mounted in series and at a spacing from each other form a filtration module, the individual filter elements being molded together and/or inserted in a holder for position stabilization purposes. The filtrate is discharged via a common filtrate collection system, to which each individual filter element is connected by means of an opening or openings in the edge region.

During molding of the plates, individual connection of the filter elements to the filtrate collection system is essential. The plate-shaped filter elements are initially combined in a plate stack, inserted in a plate holder with a filtrate collection system and then plastic is mounted around them.

Illustrated embodiments of the filter element according to the invention are illustrated in the following figures, wherein:

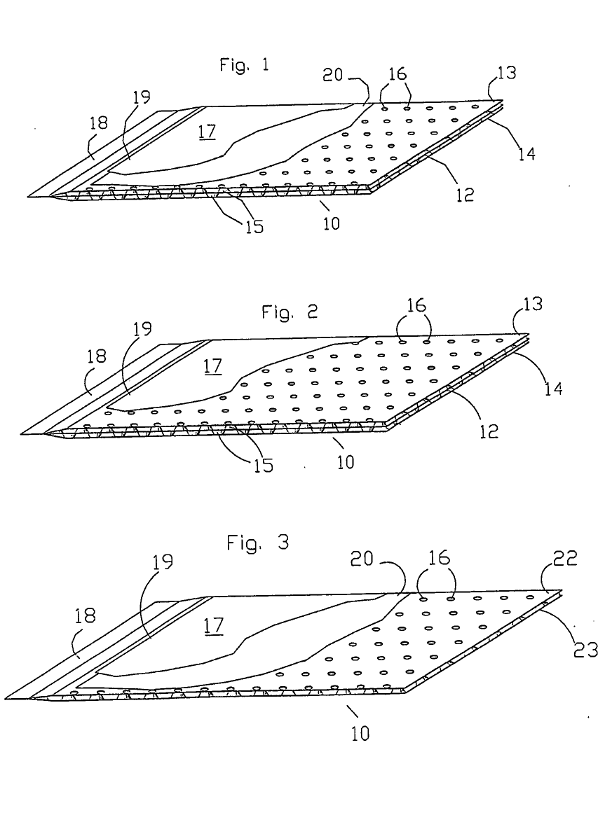

FIGS. 1 to 5 show different layer configurations of a frameless plate-shaped filtration member in section,

FIGS. 6 and 7 show a filtration module with a plurality of frameless plate-shaped filter elements.

FIG. 1 shows a sectional view of a filter element 10 according to the invention, with a layer design comprising a centrally mounted plastic film or sheet as the inner layer 12 that has nubs 15 as bumps on both faces, outer layers 13 and 14 made of a polymer being, provided flanking the inner layer 12, the layers 13 and 14 having holes 16 for conducting filtrate into the inner layer 12. A layer made of fluid-permeable gauze 20 is provided on each of the outer layers 13 and 14 that in turn is covered by a filter layer 17 made of a layer of membrane material 19. In edge regions 18, the plate-shaped filter elements are pressed, welded or glued on so that it is fluid-tight in this region.

FIG. 2 shows another embodiment of a filter element according to the invention that is suited for use with low flow rates. This design corresponds largely to the filter element according to FIG. 1, however here the inner layer made of liquid-permeable gauze 20 to support the filtrate discharge has been dispensed with.

The inner layer design illustrated in FIG. 3 shows a further simplified embodiment. For smaller sizes, where the requirements with regard to flex strength of the filter element are accordingly low, filter elements are used that comprise only two layers 22 and 23, of which one layer has nubs 15 on one face and forms the drainage layer, while the other layer, which in the region of the nubs is fixed to the inner layer according to the invention, has holes 16. On top of this, a fluid-permeable gauze 20 like in the embodiment according to FIG. 1 is provided, followed by the filter layer 17 made of a layer of membrane material 19.

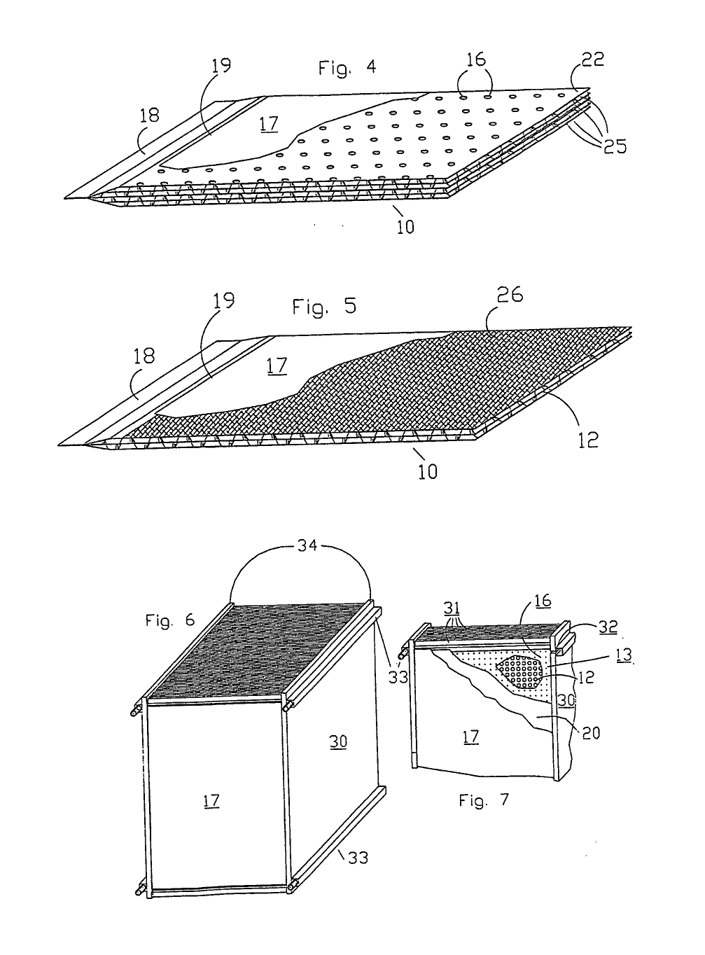

The inner layer design shown in FIG. 4 is suited for filter elements subject to particularly high flex strength requirements, for example in the case of particularly large sizes. Here, four drainage layers 25 made of nubbed film are mounted on top of and firmly bear on one another by means of the nubs. On top of this there is an outer layer 22 with holes 16 and finally the filter layer 17 comprising a layer of membrane material 19.

FIG. 5 shows a similar design of a plate-shaped filter element as FIG. 1. The two layers 13 and 14 with the holes 16 however are replaced here with a layer of tight and liquid-permeable gauze 20. It provides the filter element with sufficient strength so that an outer layer of fluid-permeable gauze 20 according to FIG. 1 can be eliminated. The gauze 26 is covered directly by the filter layer 17.

All embodiments described above can be combined to form filtration modules 30, as shown for example in FIG. 6. A plurality of filter elements 31 having the same design and the same size are mounted spaced from each other in series and oriented parallel to each other so that a fluid to be cleaned can flow evenly around the filter layers 17. The parallel orientation additionally ensures effective cleaning of the filter membrane when gas is introduced into the fluid underneath the filter elements. To stabilize the position of the filter elements, they are gripped at the edges by retaining plates 34 to which conduits of a filtrate collection system 33 are routed transversely to the filter plane. The connection of the drainage layer of the filter elements to the filtrate collection conduits is achieved via openings 32 in the edges of the plate-shaped members, which edge regions are otherwise designed to be fluid-tight.

FIG. 7 shows, by way of example, a layer design of a filter element 31 according to the invention in connection with the remaining components of a filtration module 30.

1. A frameless plate-shaped filter element, particularly for filtering fluid media, comprising outer filter layers and at least one layer of membrane material wherein between the outer filter layers at least one inner layer is provided that comprises at least on one face a plurality of bumps that are distributed across the face and mounted at a spacing from each other, the end surfaces of which bumps form a contact surface for an outer fluid-permeable layer.

2. The frameless plate-shaped filter element according to claim 1 wherein the outer fluid-permeable layer is formed with a plurality of perforations that are distributed equidistantly across the entire face.

3. The frameless plate-shaped filter element according to claim 2 wherein the perforations are at least substantially circular, have a diameter of 0.1 mm to 5 mm or a spacing from center to center of 2 mm to 50 mm.

4. The frameless plate-shaped filter element according to claim 1 wherein the bumps have a circular, oval or polygonal cross-section.

5. The frameless plate-shaped filter element according to claim 1 wherein the inner layer as well as the liquid-permeable layer are made of polymer.

6. The frameless plate-shaped filter element according to claim 1 wherein at least one surface of the inner layer has a regular structure of bumps and recesses, the bumps having a circular, oval or polygonal cross-section.

7. The frameless plate-shaped filter element according to claim 6 wherein the bumps form an abutment surface that is provided substantially parallel to the drainage layer and is suited for providing an outer layer or the filter layer.

8. The frameless plate-shaped filter element according to claim 1 wherein on the filtrate side of the filter layer at least one layer of liquid-permeable gauze is provided.

9. The frameless plate-shaped filter element according to claim 8 wherein the fluid-permeable gauze provided on the filtrate side has a small longitudinal expansion in the tensile direction.

10. The frameless plate-shaped filter element according to claim 1 wherein the filter layer is connected to at least one outer layer in the edge region by means of pressing, gluing, welding or filling.

11. The frameless plate-shaped filter element according to claim 10 wherein the edge region is completely or partially fluid-tight after forming the configuration by pressing, gluing, welding or filling.

12. The frameless plate-shaped filter element according to claim 11 wherein at least one opening is provided in the fluid-tight edge region for discharge of filtrate.

13. The frameless plate-shaped filter element according to claim 1 wherein the membrane material of the filter layer is made of polyphenol, polyether sulfone, polyvinylidenefluoride, polyamide, polyetherimide, cellulose acetate, polyolefin or fluoropolymer.

14. The frameless plate-shaped filter element according to claim 1 wherein a plurality of frameless plate-shaped filter elements that are mounted in series and at a spacing from each other, form a filtration module, the individual filter elements being molded together or insertable in a holder.

15. A filtration module comprising frameless plate-shaped filter elements according to claim 1 wherein the discharge of the filtrate occurs via a common filtrate collection system.
